(19) United States
(12) Patent Application Publication
(10) Pub. No.: US 2019/0237856 A1
(43) Pub. Date: Aug. 1, 2019

(54) Wearable Device SAR Reduction and Antenna Improvement

(71) Applicant: North Inc., Kitchener (CA)

(72) Inventor: Anttoni Juhana Valtter Rautio, Tampere (FI)

(21) Appl. No.: 16/377,710

(22) Filed: Apr. 8, 2019

Related U.S. Application Data
(63) Continuation of application No. 15/413,961, filed on Jan. 24, 2017.

(51) Int. Cl. H01Q 1/24; G02C 5/22; G02C 11/00; H01Q 1/27

(52) U.S. Cl. CPC H01Q 1/245; G02C 5/22; H01Q 5/335; H01Q 1/273; G02C 11/10

(57) ABSTRACT

A wearable electronic device includes an eyeglasses frame having a front frame and at least one temple coupled to the front frame. At least one antenna is carried within the front frame.

### CROSS-REFERENCE TO RELATED APPLICATIONS

This application is a continuation of U.S. patent application Ser. No. 15/413,961, filed 24 Jan. 2017, titled “Wearable Device SAR Reduction and Antenna Improvement”, the content of which is incorporated herein in its entirety by reference.

### TECHNICAL FIELD

Embodiments described herein generally relate to wearable electronic devices.

### BACKGROUND

There is an increasing demand for portable and wearable electronic devices. Wearable electronic devices may be worn around a wrist, affixed to clothing, implemented within eyeglasses, or implemented within other clothing articles or accessories. However, many existing solutions include a radio frequency antenna and other electronic components implemented on a PCB (printed circuit board). When the PCB is located close to or touching the user's body, the effectiveness of the antenna is reduced by the absorption of radio waves by the user's body. Further, specific absorption rate (SAR) limits are placed on the total radiated power of an electronic device near a body, such as the SAR limits defined by international authoritative bodies (e.g., IEEE C95.1:2005). It is desirable to provide an improved antenna configuration that decreases the SAR of a device and improves antenna performance.

### BRIEF DESCRIPTION OF THE DRAWINGS

FIG. 1 is a diagram of a first eyeglass electronic device top view, in accordance with at least one embodiment.

FIG. 2 is a diagram of the first eyeglass electronic device side view, in accordance with at least one embodiment.

FIG. 3 is a diagram of a second eyeglass electronic device top view, in accordance with at least one embodiment.

FIG. 4 is a diagram of the second eyeglass electronic device side view, in accordance with at least one embodiment.

FIG. 5 is a diagram of a third eyeglass electronic device side view, in accordance with at least one embodiment.

FIG. 6 is a diagram of a fourth eyeglass electronic device perspective view, in accordance with at least one embodiment.

FIG. 7 is graph of a frequency-dependent SAR function, in accordance with at least one embodiment.

FIG. 8 is graph of a frequency-dependent return loss function, in accordance with at least one embodiment.

FIG. 9 is a block diagram illustrating a radio frequency eyeglasses communication device in the example form of an electronic device, according to an example embodiment.

### DETAILED DESCRIPTION

A solution to the technical problem of improving antenna performance for wearable electronic devices includes increasing the distance between the antenna and the user's body. In the example of an electronic device implemented within eyeglasses, the antenna distance may be increased by locating the antenna on an outer rim of an eyeglasses lens. In various eyewear implementations, the antenna may be located in a location similar to an outer rim of an eyeglasses lens, but may be implemented in sunglasses, protective goggles, sport goggles, a virtual reality display, lens-less frames (e.g., smart glasses), or on other head-mounted eyewear. This increased distance between the antenna and the user's head decreases the SAR observed at the user's head. This increased distance also enables improved impedance matching and improved antenna return loss (RL), which improves antenna receiver sensitivity (RX) and increases antenna transmission (TX) effectiveness.

The following description and the drawings sufficiently illustrate specific embodiments to enable those skilled in the art to understand the specific embodiment. Other embodiments may incorporate structural, logical, electrical, process, and other changes. Portions and features of various embodiments may be included in, or substituted for, those of other embodiments. Embodiments set forth in the claims encompass all available equivalents of those claims.

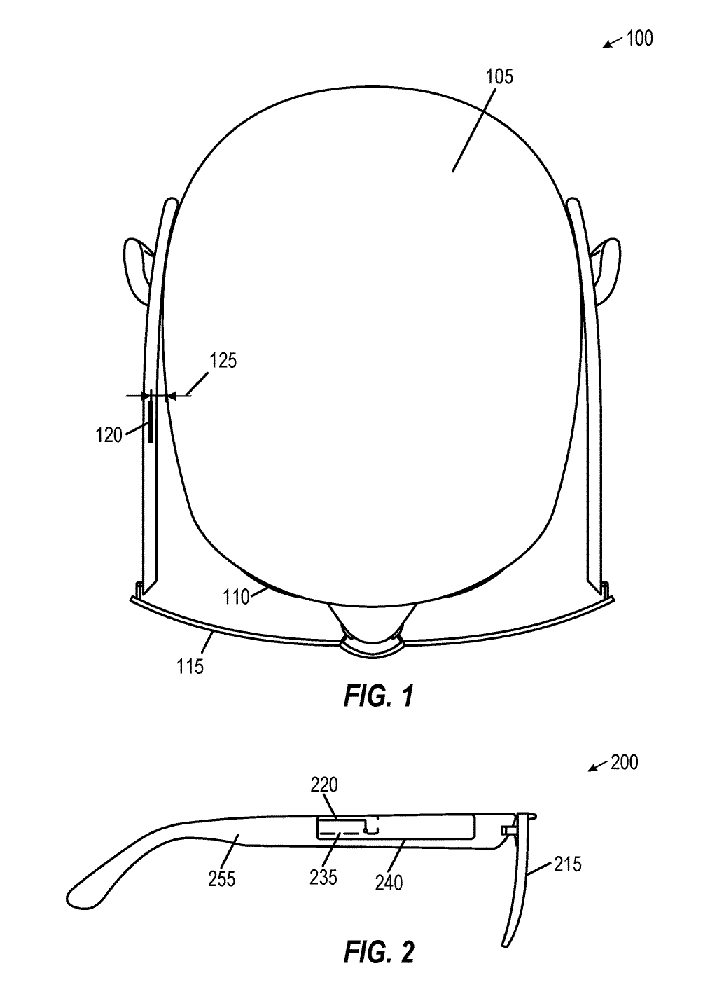

FIG. 1 is a diagram of a first eyeglass electronic device top view 100, in accordance with at least one embodiment. Top view 100 includes a user's head 105 facing downward. The user's eye 110 is pointing toward an eyeglasses lens 115. The eyeglasses include an antenna 120, where the antenna 120 is separated from the user's head 105 by a distance 125. This distance 125 may include a short distance, such as distance of about 1-2 mm. This distance 125 may provide some reduction in the SAR observed at the user's head.

FIG. 2 is a diagram of the first eyeglass electronic device side view 200, in accordance with at least one embodiment. Side view 200 shows eyeglasses that include a lens 215 and an eyeglasses temple 255, where the eyeglasses temple 255 rests on the user's ear. The temple 255 includes an antenna 220 mounted on a ground plane 235, which are both mounted on a PCB 240 on the temple 255. While mounting the antenna 220 on the PCB 240 enables a shorter antenna feed, the proximity of the antenna 220 to the user's head may still result in a high SAR and reduced antenna performance.

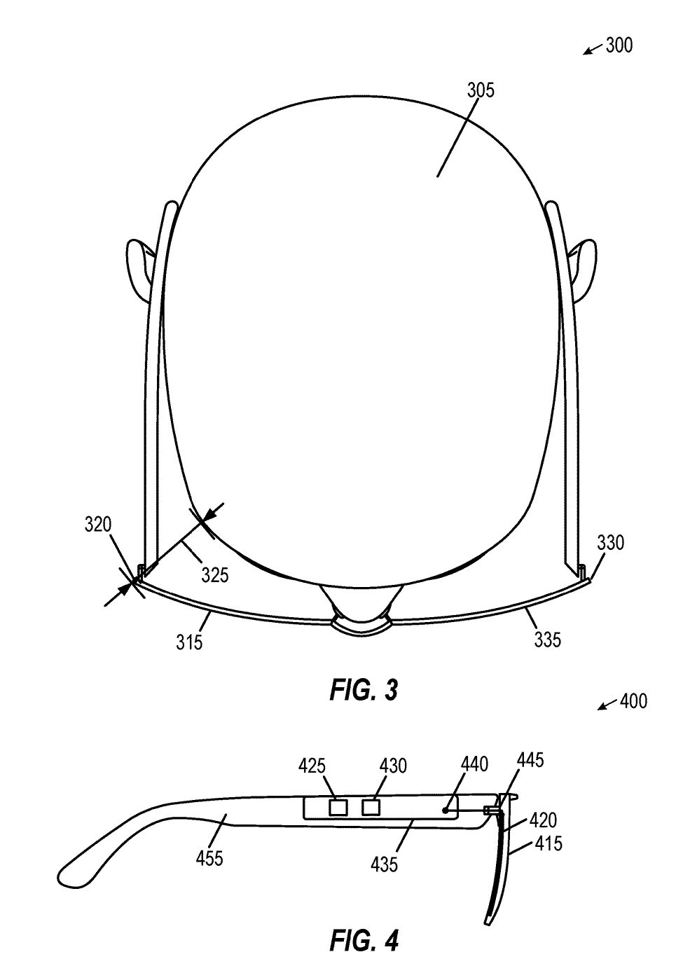

FIG. 3 is a diagram of a second eyeglass electronic device top view 300, in accordance with at least one embodiment. Top view 300 includes a user's head 305 facing downward. The antenna 320 is disposed on the outer rim of the eyeglasses lens 315. This placement significantly increases the distance 325 between the antenna 320 and the user's head 305. In an example, this distance 325 may be increase from about 1-2 mm to about 10-20 mm. Other distances may be used depending on the shape, design, and orientation of the eyeglasses.

A second antenna 330 may be disposed on the outer rim of the other eyeglasses lens 335. The combination of a first antenna 320 and second antenna 330 may be used to provide various multiple antenna configurations. For example, the antennas may form a phased array to provide beamforming and other directional signal radiation patterns. Multiple antennas may also provide spatial antenna diversity, which may reduce multipath effects or provide a clear line-of-sight to another radio frequency device. Multiple antennas may also be arranged to provide multiple communication paths, such as may be used in multiple input multiple output (MIMO) communication.

FIG. 4 is a diagram of the second eyeglass electronic device side view 400, in accordance with at least one embodiment. Side view 400 shows eyeglasses that include a lens 415 and an eyeglasses temple 455, where the eyeglasses temple 455 rests on the user's ear. The eyeglasses temple 455 includes a PCB 435 with various components, such as a system-on-a-chip (SoC) 425 and a power management integrated circuit (PMIC) 430. The components are connected via radio frequency (RF) connector 440 through an impedance matching component 445 to an antenna 420. Antenna 420 is disposed on the outer rim of the eyeglasses lens 415, where this placement reduces SAR and increases antenna performance. The impedance matching component 445 is arranged to be close to the antenna 420 to improve impedance matching, and may be attached directly to the antenna 420. In an embodiment, the matching component 445 and the antenna 420 are manufactured together, such as using laser direct structuring (LDS) to apply a metallic coating to form the matching component 445 and antenna 420. The antenna 420 may include a microstrip antenna, a monopole antenna, a dipole antenna, or another type of antenna. The length and size of the antenna 420 may include various shapes and arrangements depending on various desired characteristics, such as the size of the lens 415, the frequency response, the antenna gain, the radiation pattern, or other desired antenna characteristics. The length of antenna 415 as depicted in FIG. 4 is non-limiting. Though side view 400 shows an antenna 420 disposed on the outer rim of the eyeglasses lens 415, the antenna may be located in a similar location on different types of eyewear. For example, a similar antenna location may be used in ski googles, protective googles, virtual reality googles, lens-less frames (e.g., smart glasses), or on other head-mounted eyewear.

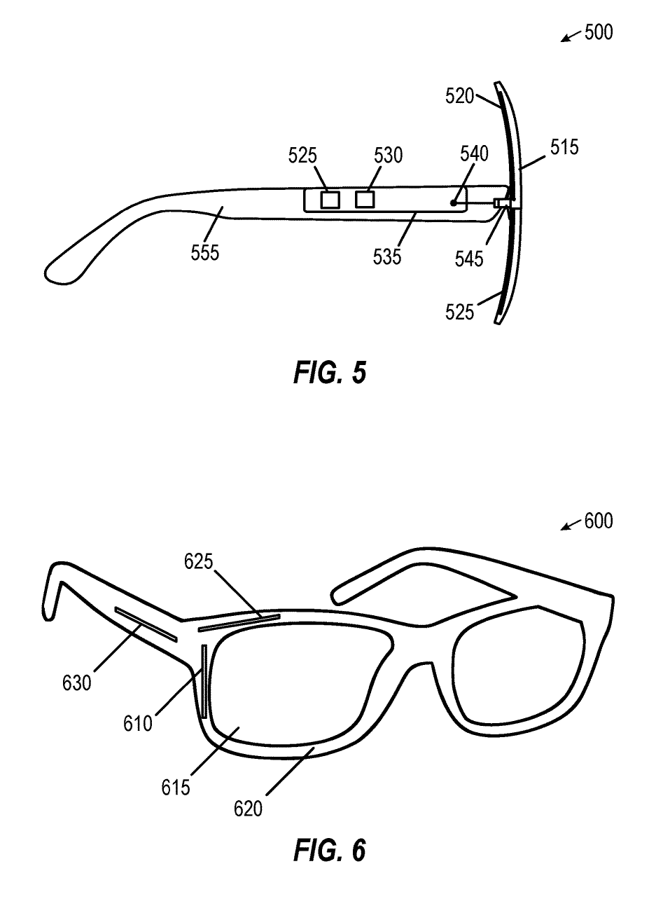

FIG. 5 is a diagram of a third eyeglass electronic device side view 500, in accordance with at least one embodiment. Side view 500 shows eyeglasses that include a lens 515 and an eyeglasses temple 555, where the temple 555 is connected to a medial (e.g., middle) portion of the lens 515. The eyeglasses temple 555 includes a PCB 535 with various components, such as a SoC 525 and a PMIC 530. The components are connected via radio frequency (RF) connector 540 through an impedance matching component 545 to a first antenna element 520 and to a second antenna element 525. The first antenna element 520 and the second antenna element 525 may be separate elements, and may be used to provide beamforming, spatial antenna diversity, MIMO communication, or other multi-antenna configurations. The first antenna element 520 and the second antenna element 525 may be connected in a dipole antenna configuration.

FIG. 6 is a diagram of a fourth eyeglass electronic device perspective view 600, in accordance with at least one embodiment. Perspective view 600 shows eyeglasses that include antenna elements in various configurations. A first antenna element 610 is disposed within an eyeglasses frame 620 or on an outer surface of frame 620. In another embodiment, eyeglasses do not include a frame surrounding the lens, and an antenna element is disposed directly on the glasses lens. A second antenna element 625 may be disposed along an upper portion of the frame 620, and a third element 630 may be disposed along a temple portion of frame 620. Additional antenna elements may be disposed in other locations throughout the frame 620 or on the eyeglasses lenses. The multiple antenna elements may be arranged to be substantially orthogonal to each other to provide predetermined radiation patterns, and may be used to provide beamforming, spatial antenna diversity, MIMO communication, or other multi-antenna features.

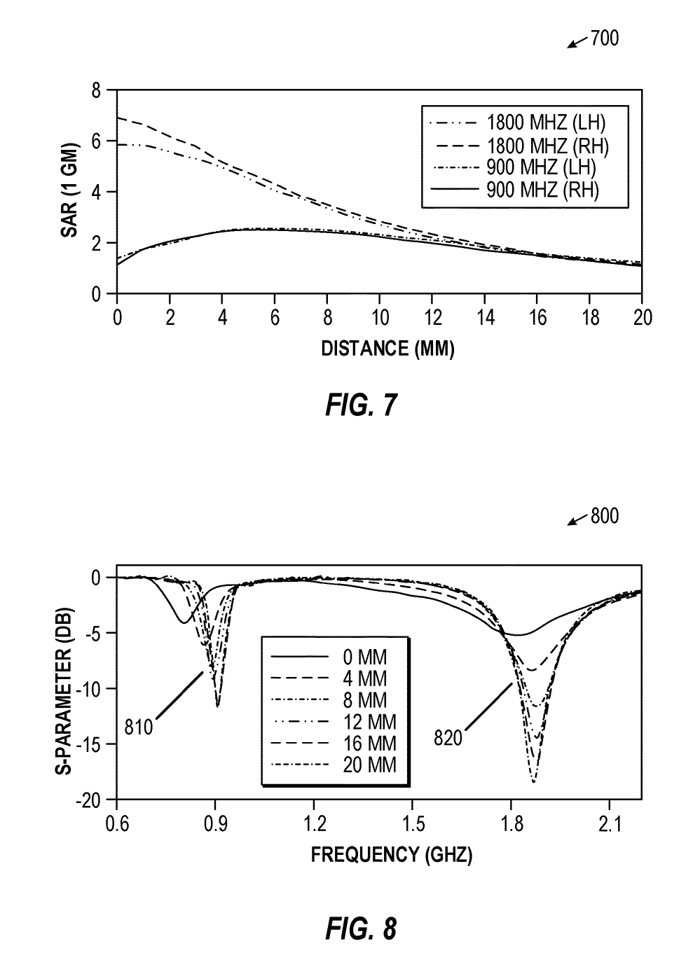

FIG. 7 is graph of a frequency-dependent SAR function 700, in accordance with at least one embodiment. SAR function 700 shows SAR values (W/kg) per 1 gram of tissue for various frequencies as a function of millimeter distance from a user's body. For lower frequencies, such as 900 MHz, the SAR increases until a distance of approximately 4 mm, then steadily decreases. In contrast, an 1800 MHz signal results in higher initial SAR values that decrease steadily. For the distance 125 of 1-2 mm in FIG. 1, this frequency-dependent difference may result in unacceptably high SAR values for 1800 MHz or higher signals. However, for the distance 325 of 10-20 mm in FIG. 3, frequencies of 900 MHz, 1800 MHz, or higher frequencies may be used while still resulting in relatively low SAR values.

FIG. 8 is graph of a frequency-dependent return loss function 800, in accordance with at least one embodiment. Return loss function 800 shows scattering parameter (S-parameter) S11 (e.g., the reflection coefficient) measured at an antenna as a function of frequency. The return loss function shows various frequencies at which the antenna is resonating, which depends on the type of wireless communication. In this example return loss function 800, the antenna exhibits a first notch 810 around 0.9 GHz (i.e., 900 MHz) and a second notch 820 around 1.8 GHz (i.e., 1800 MHz). Each notch shows a decreased return loss, where the greater the decrease in return loss (e.g., the deeper the notch) corresponds to improved antenna performance. The first notch 810 shows a return loss of approximately −4 dB for a distance of 0 mm and a return loss of approximately −12 dB for 20 mm, and this 8 dB return loss difference may result in a 6 times improvement in antenna power gain. Similarly, the second notch 820 shows a return loss of approximately −5 dB for a distance of 0 mm and a return loss of approximately −18 dB for 20 mm, and this 13 dB difference may result in a 20 times improvement in antenna power gain. While return loss function 800 shows two resonant frequencies at first notch 810 and second notch 820, one or multiple antennas may be selected or tuned to provide additional resonant frequencies (e.g., additional notches). For example, additional antennas may be selected or tuned to provide notches at Bluetooth frequencies (e.g., between 2.402 GHz and 2.480 GHz), at Wi-Fi frequencies (e.g., Wi-Fi channels around 2.4 GHz, 3.6 GHz, 4.9 GHz, 5 GHz, and 5.9 GHz), Global Navigation Satellite System (GNSS) frequencies (e.g., GPS L1 around 1.5754 GHz, GPS L2 around 1.2276 GHz), or other frequencies.

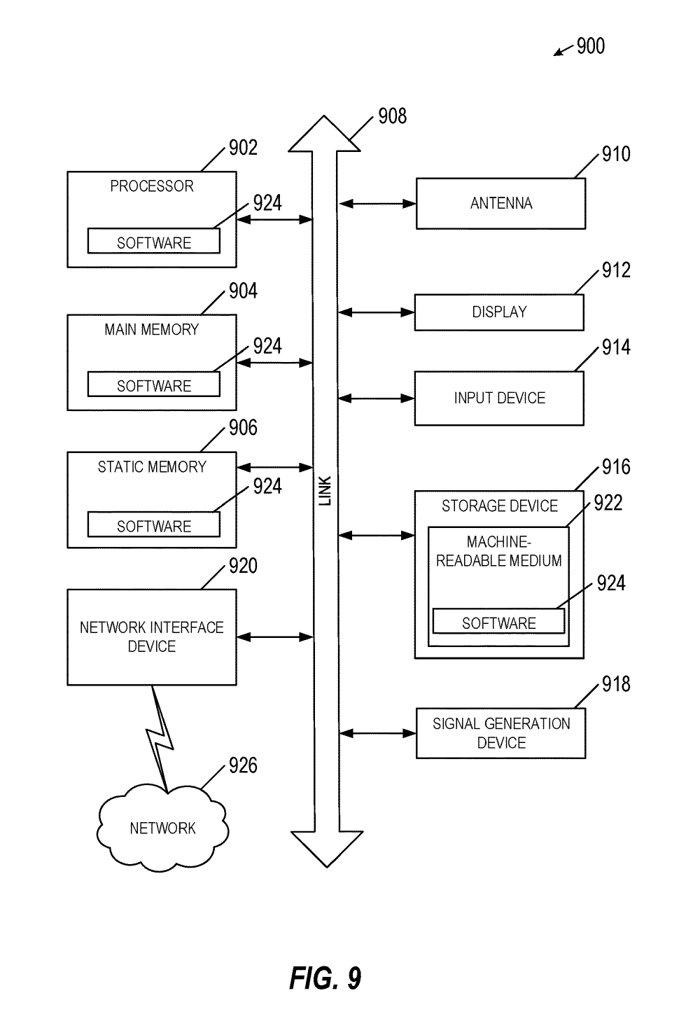

FIG. 9 is a block diagram illustrating a radio frequency eyeglasses communication device radio frequency eyeglasses communication device in the example form of an electronic device 900, within which a set or sequence of instructions may be executed to cause the machine to perform any one of the methodologies discussed herein, according to an example embodiment. Electronic device 900 may also represent the devices shown in FIGS. 1-2. In alternative embodiments, the electronic device 900 operates as a standalone device or may be connected (e.g., networked) to other machines. In a networked deployment, the electronic device 900 may operate in the capacity of either a server or a client machine in server-client network environments, or it may act as a peer machine in peer-to-peer (or distributed) network environments. The electronic device 900 may be an integrated circuit (IC), a portable electronic device, a personal computer (PC), a tablet PC, a hybrid tablet, a personal digital assistant (PDA), a mobile telephone, or any electronic device 900 capable of executing instructions (sequential or otherwise) that specify actions to be taken by that machine to detect a user input. Further, while only a single electronic device 900 is illustrated, the terms “machine” or “electronic device” shall also be taken to include any collection of machines or devices that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to execute instructions, individually or jointly, to perform any one or more of the methodologies discussed herein.

Example electronic device 900 includes at least one processor 902 (e.g., a central processing unit (CPU), a graphics processing unit (GPU) or both, processor cores, compute nodes, etc.), a main memory 904 and a static memory 906, which communicate with each other via a link 908 (e.g., bus).

The electronic device 900 includes a radio frequency eyeglasses antenna system 910, where the antenna system 910 may include an antenna, tuned antenna feed, and various antenna connections as described above. The electronic device 900 may further include a display unit 912, where the display unit 912 may include a single component that provides a user-readable display and a protective layer, or another display type. The electronic device 900 may further include an input device 914, such as a pushbutton, a keyboard, an NFC card reader, or a user interface (UI) navigation device (e.g., a mouse or touch-sensitive input). The electronic device 900 may additionally include a storage device 916, such as a drive unit. The electronic device 900 may additionally include a signal generation device 918 to provide audible or visual feedback, such as a speaker to provide an audible feedback or one or more LEDs to provide a visual feedback. The electronic device 900 may additionally include a network interface device 920, and one or more additional sensors (not shown), such as a global positioning system (GPS) sensor, compass, accelerometer, or other sensor.

The storage device 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904, static memory 906, and/or within the processor 902 during execution thereof by the electronic device 900. The main memory 904, static memory 906, and the processor 902 may also constitute machine-readable media.

While the machine-readable medium 922 is illustrated in an example embodiment to be a single medium, the term “machine-readable medium” may include a single medium or multiple media (e.g., a centralized or distributed database, and/or associated caches and servers) that store the one or more instructions 924. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 924 may further be transmitted or received over a communications network 926 using a transmission medium via the network interface device 920 utilizing any one of a number of well-known transfer protocols (e.g., HTTP). Examples of communication networks include a local area network (LAN), a wide area network (WAN), the Internet, mobile telephone networks, and wireless data networks (e.g., Wi-Fi, NFC, Bluetooth, Bluetooth LE, 3G, 3G LTE/LTE-A, WiMAX networks, etc.). The term “transmission medium” shall be taken to include any intangible medium that is capable of storing, encoding, or carrying instructions for execution by the machine, and includes digital or analog communications signals or other intangible medium to facilitate communication of such software.

To better illustrate the method and apparatuses disclosed herein, a non-limiting list of embodiments is provided here.

Example 1 is a radio frequency eyewear communication apparatus comprising: a first eyewear lens; a first eyewear temple; a first eyewear hinge; a first antenna disposed on a lateral rim of the first eyewear lens, the lateral rim proximate the first eyewear hinge; a radio frequency connector disposed on the first eyewear temple; and an impedance matching component disposed between the first antenna and the first radio frequency connector.

In Example 2, the subject matter of Example 1 optionally includes a second antenna.

In Example 3, the subject matter of Example 2 optionally includes wherein the second antenna is disposed on an opposing lateral rim of a second eyewear lens, the opposing lateral rim proximate a second eyewear hinge.

In Example 4, the subject matter of any one or more of Examples 2-3 optionally include wherein the second antenna is arranged to be substantially orthogonal to the first antenna.

In Example 5, the subject matter of any one or more of Examples 2-4 optionally include wherein the second antenna is disposed on the first eyewear temple.

In Example 6, the subject matter of any one or more of Examples 2-5 optionally include wherein the second antenna is disposed on an upper rim of the first eyewear lens.

In Example 7, the subject matter of any one or more of Examples 2-6 optionally include wherein the first antenna and second antenna form a phased array to provide beamforming.

In Example 8, the subject matter of any one or more of Examples 2-7 optionally include wherein the first antenna and second antenna are arranged to provide spatial antenna diversity.

In Example 9, the subject matter of any one or more of Examples 1-8 optionally include wherein the first antenna and second antenna are arranged to provide multiple input multiple output communication.

In Example 10, the subject matter of any one or more of Examples 1-9 optionally include wherein the antenna includes a monopole antenna, the monopole antenna including a conductive monopole element extending from the impedance matching component along the lateral rim of the eyewear lens.

In Example 11, the subject matter of Example 10 optionally includes wherein: the eyewear hinge is attached to an upper portion of the lateral rim of the eyewear lens; and the conductive monopole element extends from the impedance matching component downward along the lateral rim of the eyewear lens.

In Example 12, the subject matter of any one or more of Examples 10-11 optionally include wherein: the eyewear hinge is attached to a lower portion of the lateral rim of the eyewear lens; and the conductive monopole element extends from the impedance matching component upward along the lateral rim of the eyewear lens.

In Example 13, the subject matter of any one or more of Examples 1-12 optionally include wherein: the eyewear hinge is attached to a medial portion of the lateral rim of the eyewear lens; and the antenna includes a dipole antenna, the dipole antenna including two conductive dipole elements extending from the impedance matching component in opposite directions on the lateral rim of the eyewear lens.

In Example 14, the subject matter of any one or more of Examples 1-13 optionally include a processor disposed on the eyewear temple.

In Example 15, the subject matter of Example 14 optionally includes wherein the processor includes a system-on-a-chip.

In Example 16, the subject matter of any one or more of Examples 1-15 optionally include a power management integrated circuit disposed on the eyewear temple.

In Example 17, the subject matter of any one or more of Examples 1-16 optionally include wherein the eyewear includes at least one of eyeglasses, sunglasses, smart glasses, virtual reality display, protective goggles, and sport goggles.

Example 18 is a radio frequency eyewear communication method comprising: disposing a first antenna on a lateral rim of a first eyewear lens, the lateral rim proximate a first eyewear hinge; disposing a radio frequency connector on a first eyewear temple; and electrically connecting an impedance matching component between the first antenna and the radio frequency connector.

In Example 19, the subject matter of Example 18 optionally includes disposing a second antenna on a spatially disparate eyewear portion.

In Example 20, the subject matter of Example 19 optionally includes wherein the second antenna is disposed on an opposing lateral rim of a second eyewear lens, the opposing lateral rim proximate a second eyewear hinge.

In Example 21, the subject matter of any one or more of Examples 19-20 optionally include wherein the second antenna is arranged to be substantially orthogonal to the first antenna.

In Example 22, the subject matter of any one or more of Examples 19-21 optionally include wherein the second antenna is disposed on the first eyewear temple.

In Example 23, the subject matter of any one or more of Examples 19-22 optionally include wherein the second antenna is disposed on an upper rim of the first eyewear lens.

In Example 24, the subject matter of any one or more of Examples 19-23 optionally include wherein the first antenna and second antenna form a phased array to provide beamforming.

In Example 25, the subject matter of any one or more of Examples 19-24 optionally include wherein the first antenna and second antenna are arranged to provide spatial antenna diversity.

In Example 26, the subject matter of any one or more of Examples 19-25 optionally include wherein the first antenna and second antenna are arranged to provide multiple input multiple output communication.

In Example 27, the subject matter of any one or more of Examples 18-26 optionally include wherein the antenna includes a monopole antenna, the monopole antenna including a conductive monopole element extending from the impedance matching component along the lateral rim of the eyewear lens.

In Example 28, the subject matter of Example 27 optionally includes wherein: the eyewear hinge is attached to an upper portion of the lateral rim of the eyewear lens; and the conductive monopole element extends from the impedance matching component downward along the lateral rim of the eyewear lens.

In Example 29, the subject matter of any one or more of Examples 27-28 optionally include wherein: the eyewear hinge is attached to a lower portion of the lateral rim of the eyewear lens; and the conductive monopole element extends from the impedance matching component upward along the lateral rim of the eyewear lens.

In Example 30, the subject matter of any one or more of Examples 18-29 optionally include wherein: the eyewear hinge is attached to a medial portion of the lateral rim of the eyewear lens; and the antenna includes a dipole antenna, the dipole antenna including two conductive dipole elements extending from the impedance matching component in opposite directions on the lateral rim of the eyewear lens.

In Example 31, the subject matter of any one or more of Examples 18-30 optionally include disposing a processor on the eyewear temple.

In Example 32, the subject matter of Example 31 optionally includes wherein the processor includes a system-on-a-chip.

In Example 33, the subject matter of any one or more of Examples 18-32 optionally include disposing a power management integrated circuit on the eyewear temple.

In Example 34, the subject matter of any one or more of Examples 18-33 optionally include wherein the eyewear includes at least one of eyeglasses, sunglasses, smart glasses, virtual reality display, protective goggles, and sport goggles.

Example 35 is at least one machine-readable medium including instructions, which when executed by a computing system, cause the computing system to perform any of the methods of Examples 18-34.

Example 36 is an apparatus comprising means for performing any of the methods of Examples 18-34.

Example 37 is at least one machine-readable storage medium, comprising a plurality of instructions that, responsive to being executed with processor circuitry of a computer-controlled device, cause the computer-controlled device to: dispose a first antenna on a lateral rim of a first eyewear lens, the lateral rim proximate a first eyewear hinge; dispose a radio frequency connector on a first eyewear temple; and electrically connect an impedance matching component between the first antenna and the radio frequency connector.

In Example 38, the subject matter of Example 37 optionally includes the instructions further causing the computer-controlled device to dispose a second antenna on a spatially disparate eyewear portion.

In Example 39, the subject matter of Example 38 optionally includes wherein the second antenna is disposed on an opposing lateral rim of a second eyewear lens, the opposing lateral rim proximate a second eyewear hinge.

In Example 40, the subject matter of any one or more of Examples 38-39 optionally include wherein the second antenna is arranged to be substantially orthogonal to the first antenna.

In Example 41, the subject matter of any one or more of Examples 38-40 optionally include wherein the second antenna is disposed on the first eyewear temple.

In Example 42, the subject matter of any one or more of Examples 38-41 optionally include wherein the second antenna is disposed on an upper rim of the first eyewear lens.

In Example 43, the subject matter of any one or more of Examples 38-42 optionally include wherein the first antenna and second antenna form a phased array to provide beamforming.

In Example 44, the subject matter of any one or more of Examples 38-43 optionally include wherein the first antenna and second antenna are arranged to provide spatial antenna diversity.

In Example 45, the subject matter of any one or more of Examples 38-44 optionally include wherein the first antenna and second antenna are arranged to provide multiple input multiple output communication.

In Example 46, the subject matter of any one or more of Examples 37-45 optionally include wherein the antenna includes a monopole antenna, the monopole antenna including a conductive monopole element extending from the impedance matching component along the lateral rim of the eyewear lens.

In Example 47, the subject matter of Example 46 optionally includes wherein: the eyewear hinge is attached to an upper portion of the lateral rim of the eyewear lens; and the conductive monopole element extends from the impedance matching component downward along the lateral rim of the eyewear lens.

In Example 48, the subject matter of any one or more of Examples 46-47 optionally include wherein: the eyewear hinge is attached to a lower portion of the lateral rim of the eyewear lens; and the conductive monopole element extends from the impedance matching component upward along the lateral rim of the eyewear lens.

In Example 49, the subject matter of any one or more of Examples 37-48 optionally include wherein: the eyewear hinge is attached to a medial portion of the lateral rim of the eyewear lens; and the antenna includes a dipole antenna, the dipole antenna including two conductive dipole elements extending from the impedance matching component in opposite directions on the lateral rim of the eyewear lens.

In Example 50, the subject matter of any one or more of Examples 37-49 optionally include the instructions further causing the computer-controlled device to dispose a processor on the eyewear temple.

In Example 51, the subject matter of Example 50 optionally includes wherein the processor includes a system-on-a-chip.

In Example 52, the subject matter of any one or more of Examples 37-51 optionally include the instructions further causing the computer-controlled device to dispose a power management integrated circuit on the eyewear temple.

In Example 53, the subject matter of any one or more of Examples 37-52 optionally include wherein the eyewear includes at least one of eyeglasses, sunglasses, smart glasses, virtual reality display, protective goggles, and sport goggles.

Example 54 is a radio frequency eyewear communication apparatus comprising: means for disposing a first antenna on a lateral rim of a first eyewear lens, the lateral rim proximate a first eyewear hinge; means for disposing a radio frequency connector on a first eyewear temple; and means for electrically connecting an impedance matching component between the first antenna and the radio frequency connector.

In Example 55, the subject matter of Example 54 optionally includes means for disposing a second antenna on a spatially disparate eyewear portion.

In Example 56, the subject matter of Example 55 optionally includes wherein the second antenna is disposed on an opposing lateral rim of a second eyewear lens, the opposing lateral rim proximate a second eyewear hinge.

In Example 57, the subject matter of any one or more of Examples 55-56 optionally include wherein the second antenna is arranged to be substantially orthogonal to the first antenna.

In Example 58, the subject matter of any one or more of Examples 55-57 optionally include wherein the second antenna is disposed on the first eyewear temple.

In Example 59, the subject matter of any one or more of Examples 55-58 optionally include wherein the second antenna is disposed on an upper rim of the first eyewear lens.

In Example 60, the subject matter of any one or more of Examples 55-59 optionally include wherein the first antenna and second antenna form a phased array to provide beamforming.

In Example 61, the subject matter of any one or more of Examples 55-60 optionally include wherein the first antenna and second antenna are arranged to provide spatial antenna diversity.

In Example 62, the subject matter of any one or more of Examples 55-61 optionally include wherein the first antenna and second antenna are arranged to provide multiple input multiple output communication.

In Example 63, the subject matter of any one or more of Examples 54-62 optionally include wherein the antenna includes a monopole antenna, the monopole antenna including a conductive monopole element extending from the impedance matching component along the lateral rim of the eyewear lens.

In Example 64, the subject matter of Example 63 optionally includes wherein: the eyewear hinge is attached to an upper portion of the lateral rim of the eyewear lens; and the conductive monopole element extends from the impedance matching component downward along the lateral rim of the eyewear lens.

In Example 65, the subject matter of any one or more of Examples 63-64 optionally include wherein: the eyewear hinge is attached to a lower portion of the lateral rim of the eyewear lens; and the conductive monopole element extends from the impedance matching component upward along the lateral rim of the eyewear lens.

In Example 66, the subject matter of any one or more of Examples 54-65 optionally include wherein: the eyewear hinge is attached to a medial portion of the lateral rim of the eyewear lens; and the antenna includes a dipole antenna, the dipole antenna including two conductive dipole elements extending from the impedance matching component in opposite directions on the lateral rim of the eyewear lens.

In Example 67, the subject matter of any one or more of Examples 54-66 optionally include means for disposing a processor on the eyewear temple.

In Example 68, the subject matter of Example 67 optionally includes wherein the processor includes a system-on-a-chip.

In Example 69, the subject matter of any one or more of Examples 54-68 optionally include means for disposing a power management integrated circuit on the eyewear temple.

In Example 70, the subject matter of any one or more of Examples 54-69 optionally include wherein the eyewear includes at least one of eyeglasses, sunglasses, smart glasses, virtual reality display, protective goggles, and sport goggles.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. In the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope should be determined with reference to the appended claims, along with the full scope of equivalents to which such claims are entitled.

1. A wearable electronic device, comprising:
an eyeglasses frame including a front frame and at least one temple coupled to the front frame; and
at least one antenna carried within the front frame.

2. The wearable electronic device of claim 1, further comprising an eyeglass, wherein a portion of the front frame is disposed adjacent to at least a portion of a perimeter of the eyeglass.

3. The wearable electronic device of claim 2, wherein the at least one antenna is carried within the portion of the front frame that is disposed adjacent to at least a portion of the perimeter of the eyeglass.

4. The wearable electronic device of claim 3, wherein the at least one antenna is carried within a portion of the front frame that is disposed adjacent to an upper portion of the perimeter of the eyeglass.

5. The wearable electronic device of claim 3, wherein the at least one antenna is carried within a portion of the front frame that is disposed adjacent to a side portion of the perimeter of the eyeglass.

6. The wearable electronic device of claim 3, further comprising a second antenna carried within the portion of the front frame that is disposed adjacent to the at least a portion of the perimeter of the eyeglass.

7. The wearable electronic device of claim 6, wherein the at least one antenna and the second antenna are arranged to be substantially orthogonal to each other.

8. The wearable electronic device of claim 1, further comprising at least one antenna carried by the at least one temple.

9. The wearable electronic device of claim 8, wherein the at least one antenna carried within the front frame and the at least one antenna carried by the at least one temple are arranged to be substantially orthogonal to each other.

10. The wearable electronic device of claim 1, further comprising a radio frequency connector carried by the at least one temple.

11. The wearable electronic device of claim 10, further comprising an impedance matching component disposed between the at least one antenna and the radio frequency connector.
